(19) United States
(12) Patent Application Publication
(10) Pub. No.: US 2023/0313570 A1
(43) Pub. Date: Oct. 5, 2023

(54) POWER CHILD LOCK ACTUATOR

(71) Applicant: INTEVA PRODUCTS, LLC, Troy, MI (US)

(72) Inventors: Donald Michael Perkins, Rochester Hills, MI (US); Daniel Alexander Ney, Lake Orion, MI (US)

(21) Appl. No.: 18/128,788

(22) Filed: Mar. 30, 2023

Related U.S. Application Data
(60) Provisional application No. 63/326,051, filed on Mar. 31, 2022.

(51) Int. Cl. E05B 77/26; E05B 81/36; E05B 81/06; E05B 81/16; E05B 81/56; E05B 81/74

(52) U.S. Cl. CPC E05B 77/265; E05B 81/36; E05B 81/06; E05B 81/16; E05B 81/56; E05B 81/74

(57) ABSTRACT

A latch assembly, including: a manual release lever rotationally mounted to the latch assembly for movement about a first axis, the manual release lever being operably coupled to an inside release handle; a release link pivotally mounted to the manual release lever for movement about a second axis; a child lock lever rotationally mounted to the latch assembly for movement about a third axis; a gear rotationally mounted to the latch assembly for movement about a fourth axis, the gear being rotated by a motor that drives a worm that meshingly engages teeth of the gear; a child lock switch positioned to detect a position of the child lock lever; a gear home switch positioned to detect the position of the gear; and wherein the gear has a first cam surface configured to contact a cam surface of the child lock lever when the gear is rotated to a locked position and contact of the first cam surface with the cam surface of the child lock lever will rotate the child lock lever about the third axis and rotation of the child lock lever about the third axis will cause the release link to pivot about the second axis.

### CROSS REFERENCE TO RELATED APPLICATIONS

The present application claims priority to U.S. Provisional Application Ser. No. 63/326,051 filed on Mar. 31, 2022, the entire contents of which are incorporated herein by reference thereto.

### TECHNICAL FIELD

Exemplary embodiments of the present disclosure pertain to the art of vehicle latches and more particularly, child lock mechanism for vehicle latches.

### BACKGROUND

Child lock mechanisms are typically found in vehicles. The child lock mechanism is a function found on rear door release mechanisms that will not allow the release of the door from the inside handle when the feature is activated. This can be accomplished in the door latch assembly by decoupling the inside release handle from the remaining release mechanism. This decoupling can be realized by manual or electromechanical means.

When an electromechanical device is applied to provide the child locking function, it often requires a unique DC motor and drivetrain to engage/disengage the system. As such, another motor is required to be included in the latch in order to provide electromechanical activation of the child lock mechanism. Accordingly it is desirable to provide another way to electromechanically actuate the child lock mechanism without adding an additional motor to the latch.

### BRIEF DESCRIPTION

Disclosed is a latch assembly, including: a manual release lever rotationally mounted to the latch assembly for movement about a first axis, the manual release lever being operably coupled to an inside release handle; a release link pivotally mounted to the manual release lever for movement about a second axis; a child lock lever rotationally mounted to the latch assembly for movement about a third axis; a gear rotationally mounted to the latch assembly for movement about a fourth axis, the gear being rotated by a motor that drives a worm that meshingly engages teeth of the gear; a child lock switch positioned to detect a position of the child lock lever; a gear home switch positioned to detect the position of the gear; and wherein the gear has a first cam surface configured to contact a cam surface of the child lock lever when the gear is rotated to a locked position and contact of the first cam surface with the cam surface of the child lock lever will rotate the child lock lever about the third axis and rotation of the child lock lever about the third axis will cause the release link to pivot about the second axis.

In addition to one or more of the features described above, or as an alternative to any of the foregoing embodiments, rotation of the gear to the locked position will decouple the manual release lever from a pawl of the latch assembly.

In addition to one or more of the features described above, or as an alternative to any of the foregoing embodiments, rotation of the gear to the locked position will cause the child lock lever to contact the child lock switch.

In addition to one or more of the features described above, or as an alternative to any of the foregoing embodiments, the first cam surface of the gear is integrally molded with the gear such that the first cam surface of the gear and the gear are formed as a single component.

In addition to one or more of the features described above, or as an alternative to any of the foregoing embodiments, the child lock switch and the gear home switch are coupled to a controller that controls the operation of the latch assembly by providing signals to the motor in order to rotate the gear.

In addition to one or more of the features described above, or as an alternative to any of the foregoing embodiments, a power release lever is rotatably mounted to the latch assembly for movement about the third axis, wherein rotation of the power release lever by the gear causes a pawl of the latch assembly to be disengaged from a claw of the latch assembly.

In addition to one or more of the features described above, or as an alternative to any of the foregoing embodiments, the power release lever rotates independently of the child lock lever.

In addition to one or more of the features described above, or as an alternative to any of the foregoing embodiments, the gear has a second cam surface that engages an upper portion of the power release lever as the gear is rotated by the worm.

In addition to one or more of the features described above, or as an alternative to any of the foregoing embodiments, the second cam surface is integrally formed with the gear such that the second cam surface rotates with the gear and the second cam surface and the gear are formed as a single component.

In addition to one or more of the features described above, or as an alternative to any of the foregoing embodiments, a lower portion of the power release lever contacts a pawl release lever operably coupled to the pawl when the power release lever is rotated by the gear.

In addition to one or more of the features described above, or as an alternative to any of the foregoing embodiments, a lower portion of the power release lever contacts a pawl release lever operably coupled to the pawl when the power release lever is rotated by the gear.

In addition to one or more of the features described above, or as an alternative to any of the foregoing embodiments, operation of the motor in a first direction will move the power release lever and operation of the motor in a second direction opposite to the first direction will move the child lock lever.

In addition to one or more of the features described above, or as an alternative to any of the foregoing embodiments, rotation of the gear to the locked position will decouple the manual release lever from a pawl of the latch assembly.

In addition to one or more of the features described above, or as an alternative to any of the foregoing embodiments, rotation of the gear to the locked position will cause the child lock lever to contact the child lock switch.

In addition to one or more of the features described above, or as an alternative to any of the foregoing embodiments, the first cam surface of the gear is integrally molded with the gear such that the first cam surface of the gear and the gear are formed as a single component.

In addition to one or more of the features described above, or as an alternative to any of the foregoing embodiments, the child lock switch and the gear home switch are coupled to a controller that controls the operation of the latch assembly by providing signals to the motor in order to rotate the gear.

In addition to one or more of the features described above, or as an alternative to any of the foregoing embodiments, operation of the motor in a first direction will move the power release lever and operation of the motor in a second direction opposite to the first direction will move the child lock lever.

Also disclosed is a method of operating a latch assembly, including: decoupling a manual release lever from a pawl of the latch assembly by rotating a gear in a first direction by a motor; and moving the pawl by rotating the gear in a second direction by the motor, the second direction being opposite to the first direction.

### BRIEF DESCRIPTION OF THE DRAWINGS

The following descriptions should not be considered limiting in any way. With reference to the accompanying drawings, like elements are numbered alike:

FIG. 1 illustrates components of a latch assembly in accordance with the present disclosure;

FIGS. 2 and 3 illustrate a claw, pawl and pawl release lever of a latch assembly in accordance with the present disclosure;

FIG. 4 illustrates components of a power child lock system of the latch assembly in accordance with the present disclosure;

FIG. 5 illustrates an inside release lever and a release link of the latch assembly in accordance with the present disclosure;

FIGS. 6 and 7 illustrate the interface between the child lock lever and the release link of the present disclosure;

FIG. 8 illustrates an interface between the child lock lever and a gear of a power lock system of the latch assembly in accordance with the present disclosure when the child lock lever is in a “locked” state;

FIG. 9 illustrates an interface between the child lock lever and a gear of a power lock system of the latch assembly in accordance with the present disclosure when the child lock lever is in a “unlocked” state;

FIG. 10 illustrates the power child lock system in an “unlocked” state;

FIG. 11 illustrates the power child lock system in an “unlocked” state when the inside release lever has been actuated;

FIG. 12 illustrates the power child lock system in an “locked” state;

FIG. 13 illustrates the power child lock system in an “locked” state when the inside release lever has been actuated;

FIG. 14 illustrates components of a latch assembly in accordance with the present disclosure; and

FIGS. 15A-15C illustrate movement of a power release lever in accordance with the present disclosure.

### DETAILED DESCRIPTION

A detailed description of one or more embodiments of the disclosed apparatus and method are presented herein by way of exemplification and not limitation with reference to the Figures.

Disclosed is a latch that provides the child lock function using an existing motor within the same latch subassembly such as a motor used for a central lock or power release function. By creating a multipurpose actuator that will share one motor, cost benefits can be realized.

For this particular application, the latching system is an electric release latch, and the child lock system is activated via a motor which is controlled by system logic or a button that can be activated by the driver. The secondary requirement of this system is that one motor must provide the functionality of power child lock as well as the electric release of the latch. In order to do this the system must be able to distinguish whether the system is in a locked state, unlocked state, or releasing state, and must be able to accurately and consistently control and position a gear to start and stop at any of these positions.

The present disclosure allows for a power child lock to be integrated into an electric release latch and utilize the same motor and gear that provides the electric release function. The key to this system is providing three distinct and detectable positions or zones of travel for the release gear. There must be a “release zone” where the gear is driving the release system to open the latch, a “locked zone” where the gear has disengaged an inside release handle from a pawl release lever, and a “home” or “unlocked zone” where the gear is not driving the child lock or release system. In order to detect these three zones, two switches are used to determine the current state of the gear.

A “gear home” switch is used to determine if the gear is in the “release zone”. If this switch is on, then the system knows that the gear is driving a pawl or detent of the latch open. The second switch is a “child lock” switch which determines if the gear is driving the child lock lever to a locked state. If both switches are off, then the system knows that it is in the “home zone” or “unlocked zone”.

For the mechanical functionality of the system, there are two primary ways to provide the child lock function for this mechanism, a 2-lever system or a 1-lever system. For the 2-lever system, a child lock lever is used to engage or disengage the inside release handle lever from the pawl release lever. In this particular system, a release link is attached to the inside release lever which is toggled to engage or disengage with the pawl release lever by the child lock lever. So, in summary, the gear moves the child lock lever, which moves the release link to either be engaged or disengaged with the pawl release lever. The secondary set up of this system is to dual purpose the power release lever to also provide the functionality that the child lock lever provides. In this alternative set up, the power release lever would have a “release zone”, a “home zone” or a “unlocked zone”, and “locked” position, like the gear. So rather than being two separate levers, the functionality of both is provided by one single lever. The advantage of the two-lever design is primarily packaging and a reduction in required travel by the levers, while the one-lever design removes a component.

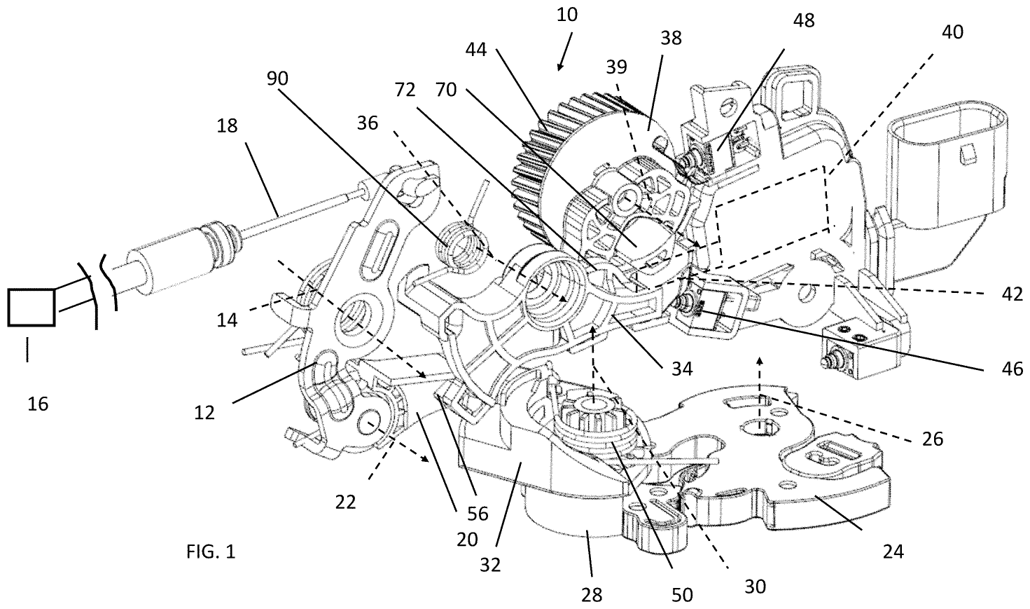

FIG. 1 illustrates components of a latch assembly 10 in accordance with the present disclosure. The latch assembly 10 includes a manual release lever 12 rotationally mounted to the latch assembly for movement about an axis 14. The manual release lever 12 is operably coupled to an inside release handle 16 via a cable 18. A release link 20 is pivotally mounted to the manual release lever 12 for movement about an axis 22.

The latch assembly also includes a claw 24 rotationally mounted to the latch assembly 10 for rotation about an axis 26 and for engagement and release of a striker (not shown) as is known in the related arts. A pawl 28 is also rotationally mounted to the latch assembly 10 for rotation about an axis 30 for engagement and disengagement with the claw 24 in order to maintain the claw 24 in a primary or secondary state (e.g., closed) or to allow the claw 24 to rotate into an open position (e.g., disengaged position of pawl 26). Also shown is a pawl release lever 32 that is rotationally mounted for movement about axis 30. The pawl release lever 32 is operably coupled to the pawl 28 such that rotation of the pawl release lever 32 will cause a corresponding movement of the pawl 28.

In certain conditions and depending upon the state the power child lock system, the release link 22 is operably secured to the pawl release lever 32 such that movement of the release link 20 via movement of the manual release lever will cause the pawl release lever 32 to rotate and the pawl 28 will be disengaged from the claw and the latch 10 will open.

A child lock lever 34 of the latch assembly 10 is rotationally mounted to the latch assembly 10 for movement about an axis 36. A gear 38 is rotationally mounted to the latch assembly 10 for movement about an axis 39. The gear 38 is rotated by a motor 40 (illustrated by dashed lines) that drives a worm 42 (illustrated by dashed lines) which meshingly engages teeth 44 of the gear 38. A child lock switch 46 is positioned to detect the position of the child lock lever 34 and a gear home switch 48 is positioned to detect the position of the gear 38.

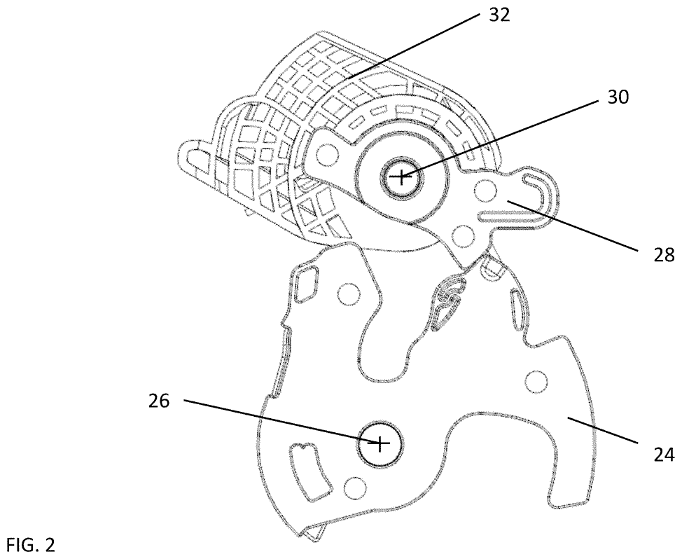

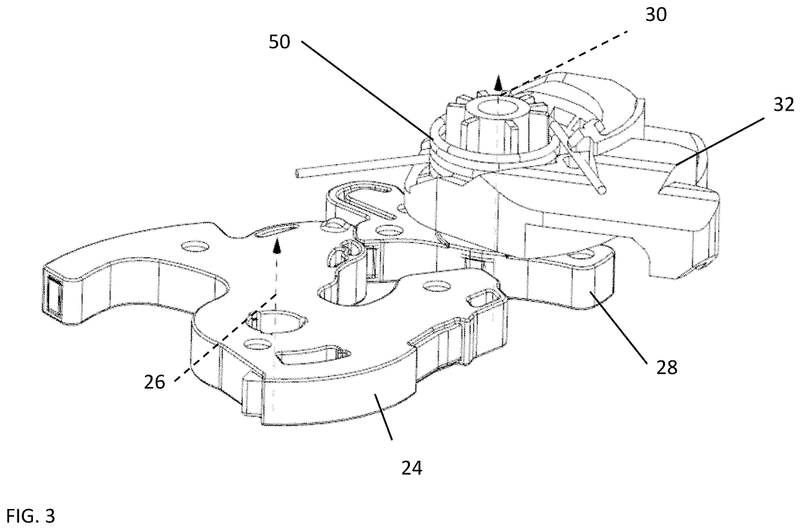

FIGS. 2 and 3 illustrate the claw 24, the pawl 28 and the pawl release lever 28 of the latch assembly in accordance with the present disclosure. Also shown is a spring 50 for providing a biasing force to the pawl release lever 28.

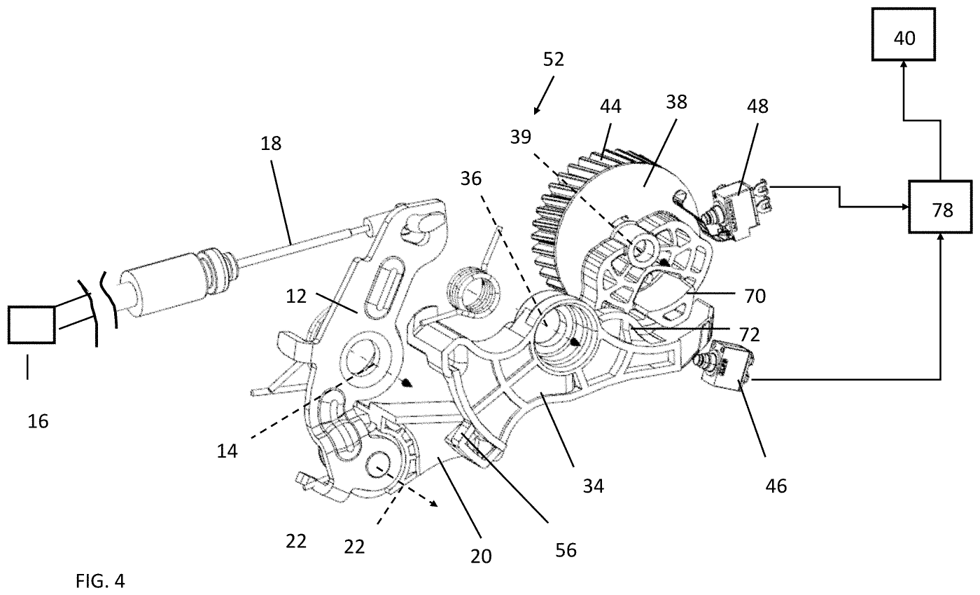

FIG. 4 illustrates components of a power lock system 52 of the latch assembly 10 in accordance with the present disclosure.

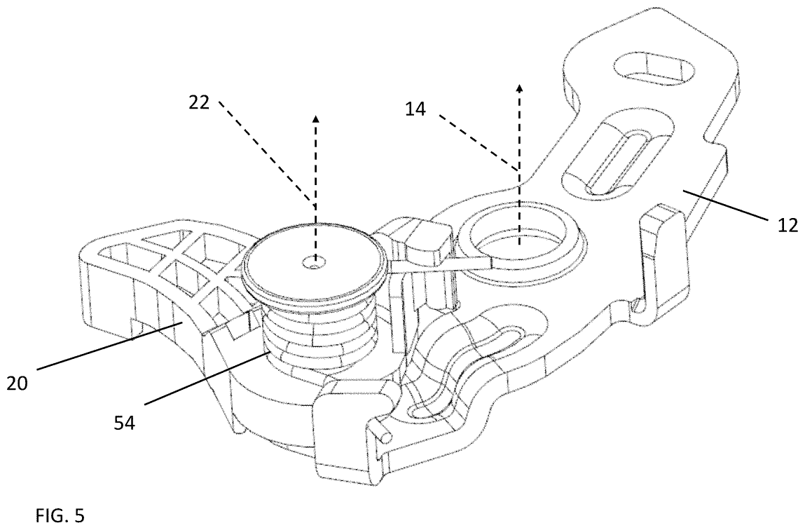

FIG. 5 illustrates the inside release lever 12 and the release link 20 of the latch assembly 10 in accordance with the present disclosure. The release link 20 pivots on the inside release lever 12, off axis from the inside release lever's pivot axis 14. The release link 20 is spring biased in a counter clock wise direction with respect to the image shown in FIG. 5 by a spring 54.

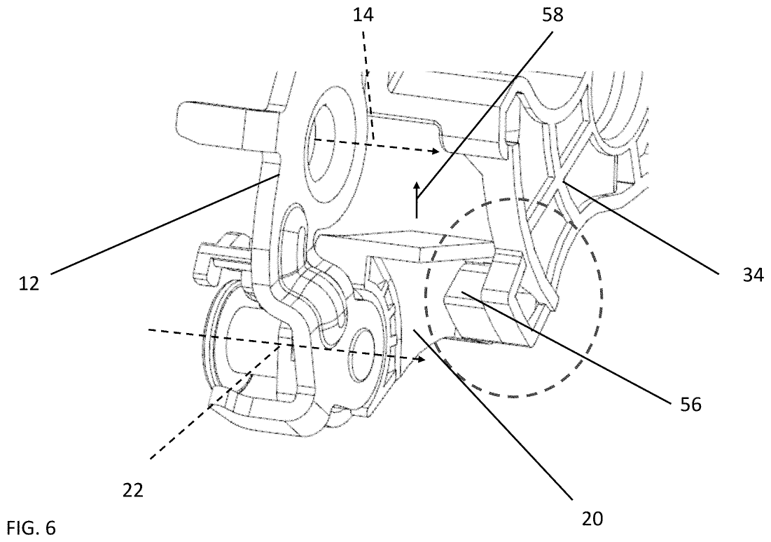

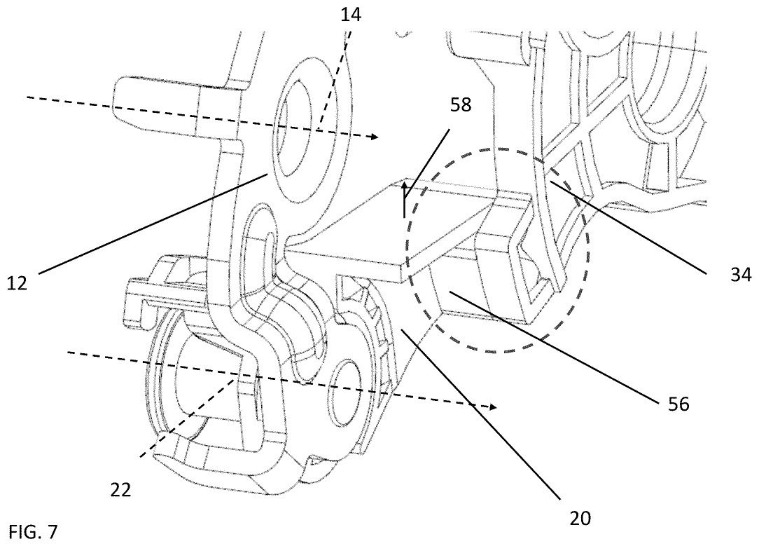

FIGS. 6 and 7 illustrate the interface between the child lock lever 34 and the release link 20 of the present disclosure. A boss 56 on the child lock lever 34 is used to lift the release link 20 in the direction of arrow 58 in order to lock the latch assembly with the power child lock system 52. This interface is illustrated in the areas circled by the dashed lines in FIGS. 6 and 7.

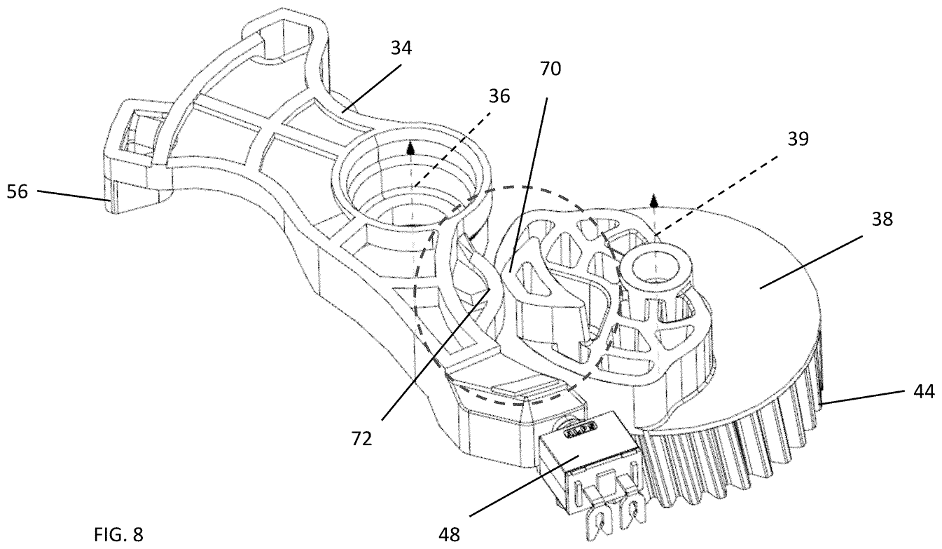

FIG. 8 illustrates an interface between the child lock lever 34 and the gear 38 of the power lock system 52 of the latch assembly 10 in accordance with the present disclosure when the child lock lever 34 is in a “locked” state. The child lock lever 34 is moved to the “locked” state by the gear 38. The gear 38 has a gear cam or cam surface or first cam surface 70 that is integrally formed with the gear 38 such that the gear cam 70 rotates with the gear 38 and the cam surface 70 and the gear 38 are formed as a single component. The gear cam 70 is configured to engage a cam surface 72 of the child lock lever 34. When the gear cam 70 contacts the cam surface 72 of the child lock lever 34 the child lock lever 34 is rotated about axis 36. This contact is illustrated in the area indicated by the dashed lines in FIG. 8. The child lock lever 34 is spring biased counter clock wise in FIG. 8. In the position illustrated in FIG. 8 the child lock lever 34 contacts the child lock switch 48 such that the child lock switch 48 is ON when the child lock lever 34 is in the “locked” state.

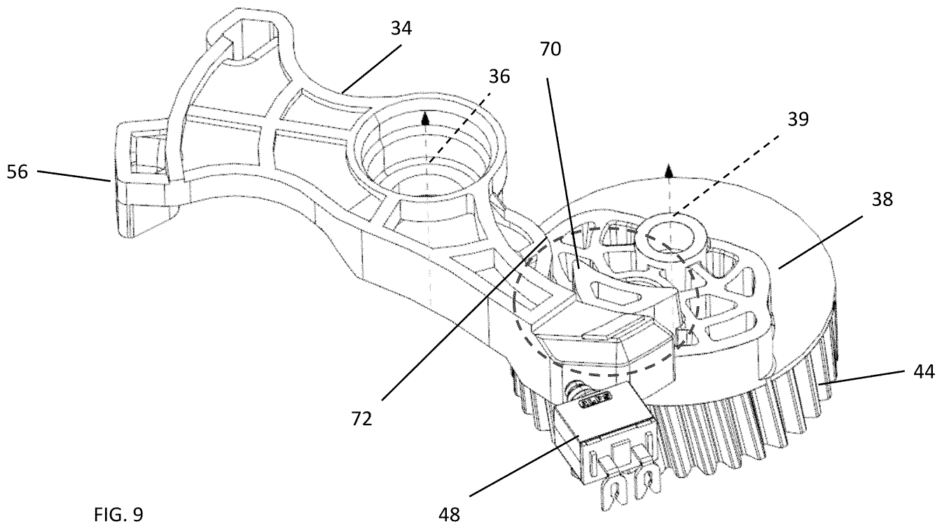

FIG. 9 illustrates an interface between the child lock lever 34 and the gear 38 of the power lock system 52 of the latch assembly 10 in accordance with the present disclosure when the child lock lever 34 is in an “unlocked” state. The child lock lever 34 is moved to the “unlocked” state as the gear cam 70 no longer contacts the cam surface 72 of the child lock lever 34. This lack of contact is illustrated in the area indicated by the dashed lines in FIG. 9. Due to the lack of contact between the gear cam 70 and the cam surface 72 and the counter clock wise biasing of the child lock lever 34 in the counter clock wise direction in FIG. 8 the child lock lever 34 rotates counter clock wise and no longer contacts the child lock switch 48 such that the child lock switch 48 is OFF when the child lock lever 34 is in the “unlocked” state.

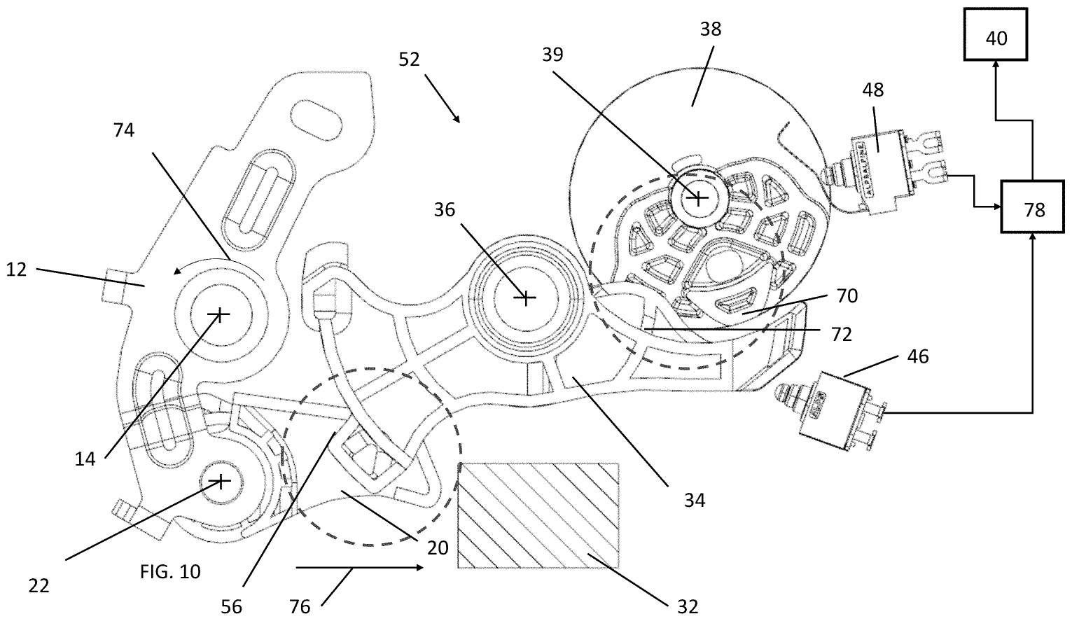

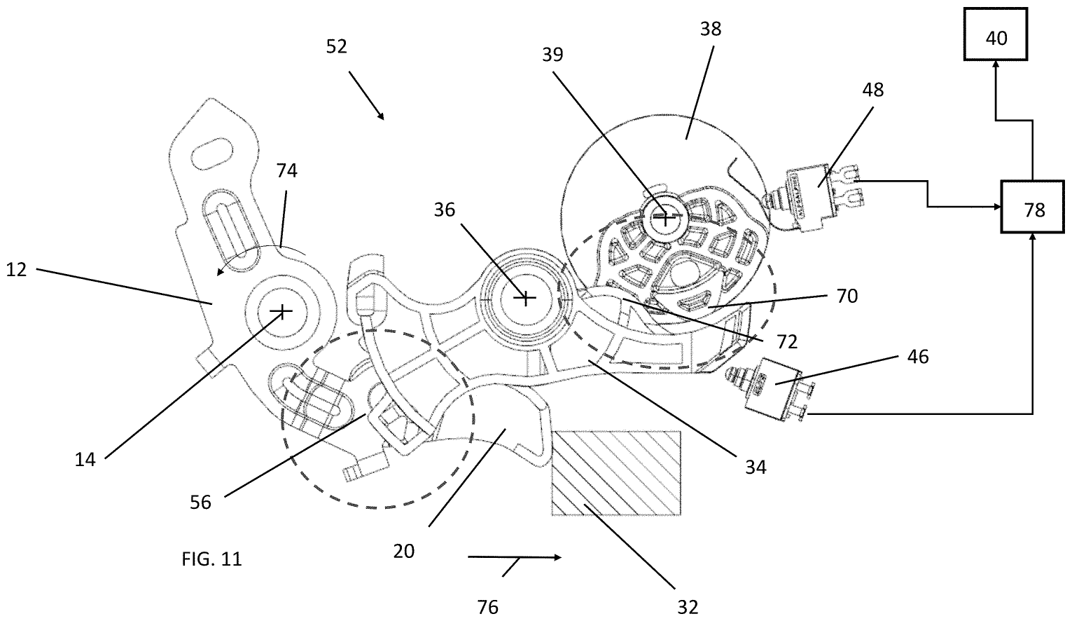

As illustrated in FIG. 10, the child lock lever 34 is in the “unlocked” state. As such and when the manual release lever 12 is rotated in the direction of arrow 74 the release link 20 moves in the direction of arrow 76 until it contacts the pawl release lever 32 which in turn is rotated about axis 30 and pawl 28 is rotated away from the claw 24. This movement is illustrated in FIG. 11. In FIGS. 10 and 11 both switches 46 and 48 not actuation and they are in the off condition.

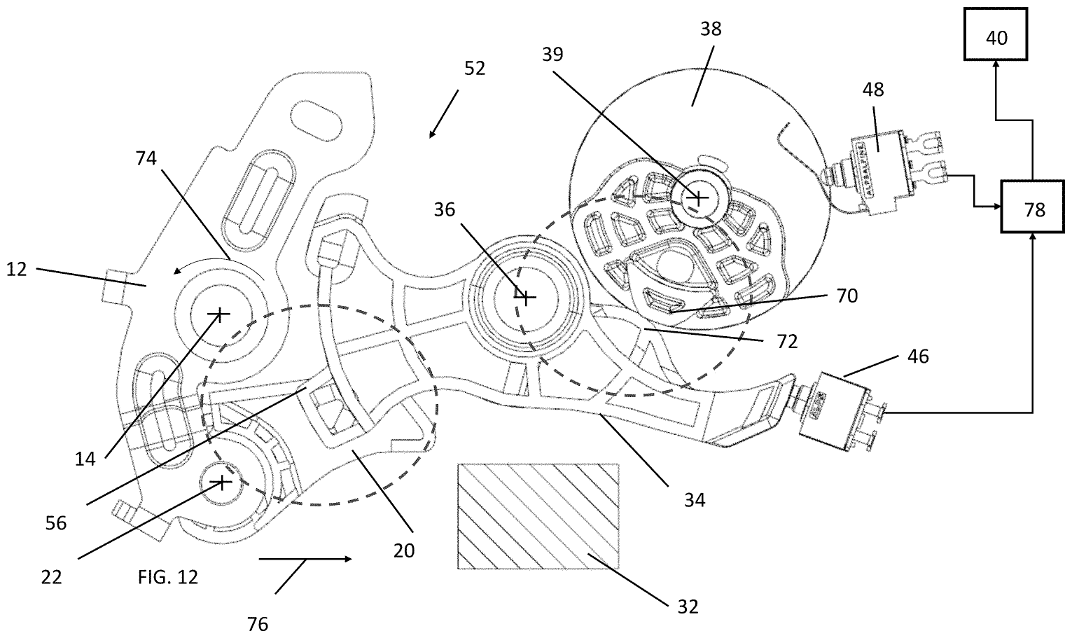

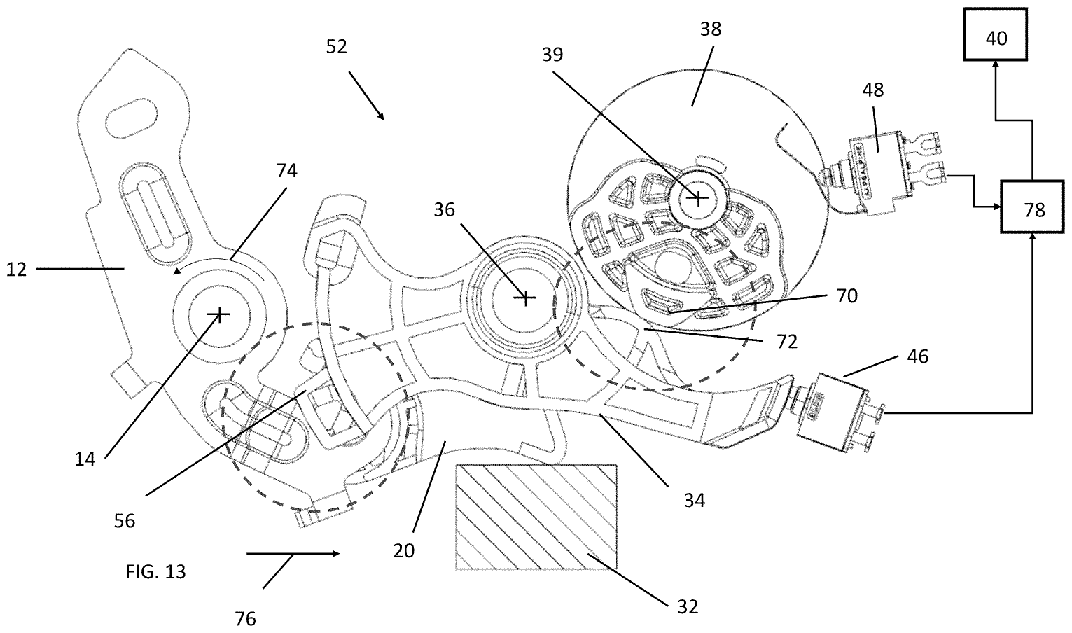

As illustrated in FIG. 12, the child lock lever 34 is in the “locked” state. As such and when the manual release lever 12 is rotated in the direction of arrow 74 the release link 20 moves in the direction of arrow 76 however it does not contact the pawl release lever 32 and the pawl 28 is not rotated away from the claw 24. This movement is illustrated in FIG. 13. In FIGS. 12 and 13 switch 46 is actuated such that is in an on condition.

Switches 46 and 48 are coupled to a controller, microcontroller or processor 78 which controls the operation of the latch assembly 10 by providing signals to motor 40 in order to rotate gear 38.

The latch assembly 10 utilizes effective logic from the switches 46 and 48 to control the release gear 38 to start and stop at various points/zones of travel to control the power child lock system 52, therefore allowing for one gear 38 and motor 40 to provide child lock and power release functions. The child lock lever 34 is driven to the “locked” state by the gear 38 or power release gear 38, which disengages the release link 20 from the pawl release lever 32.

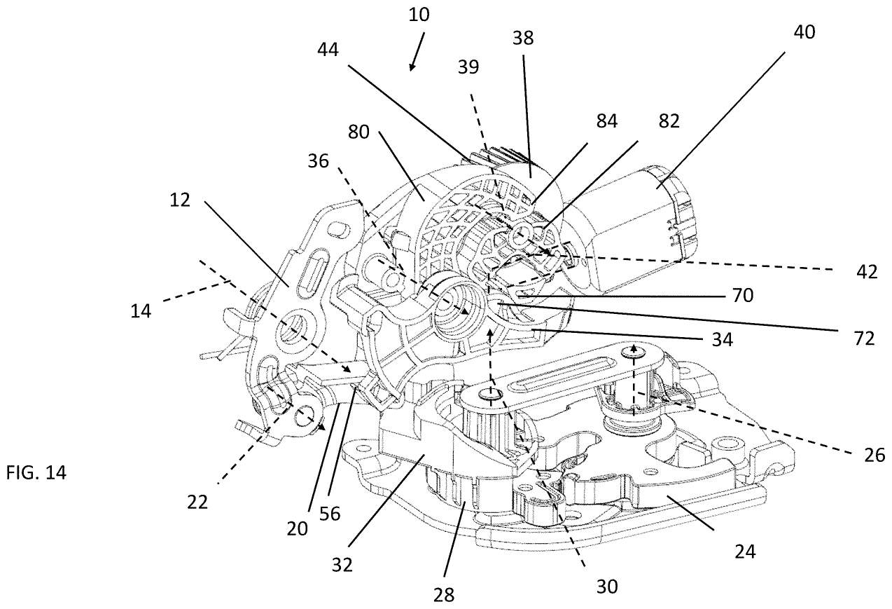

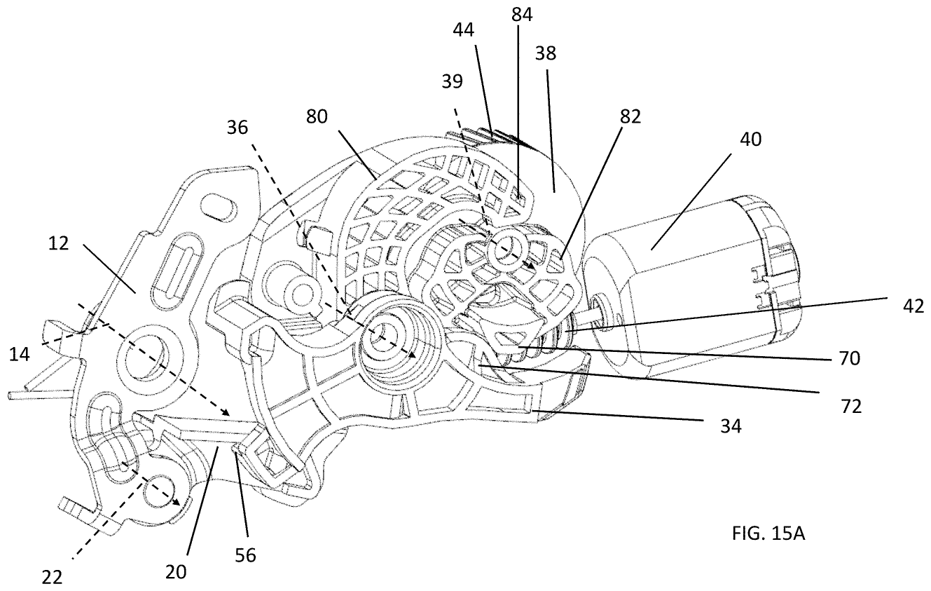

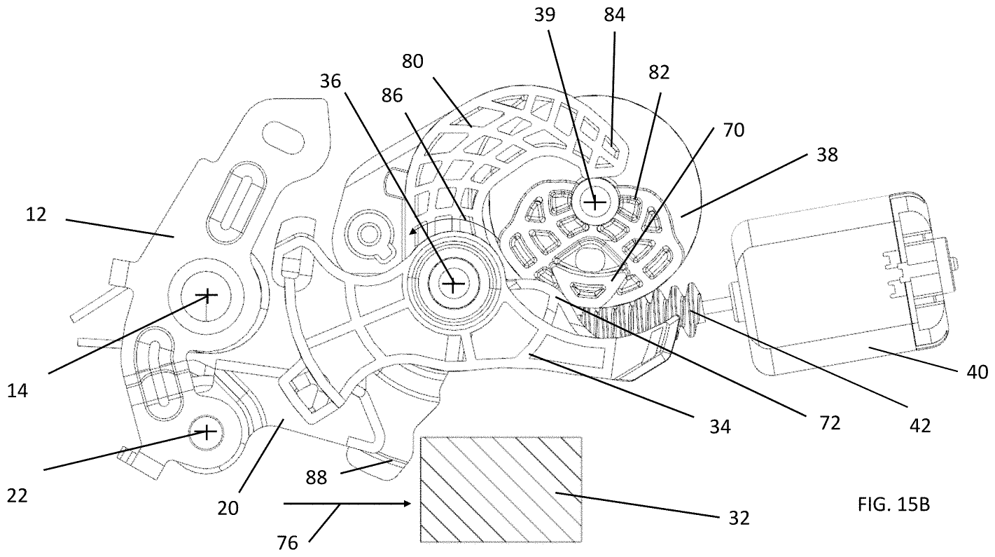

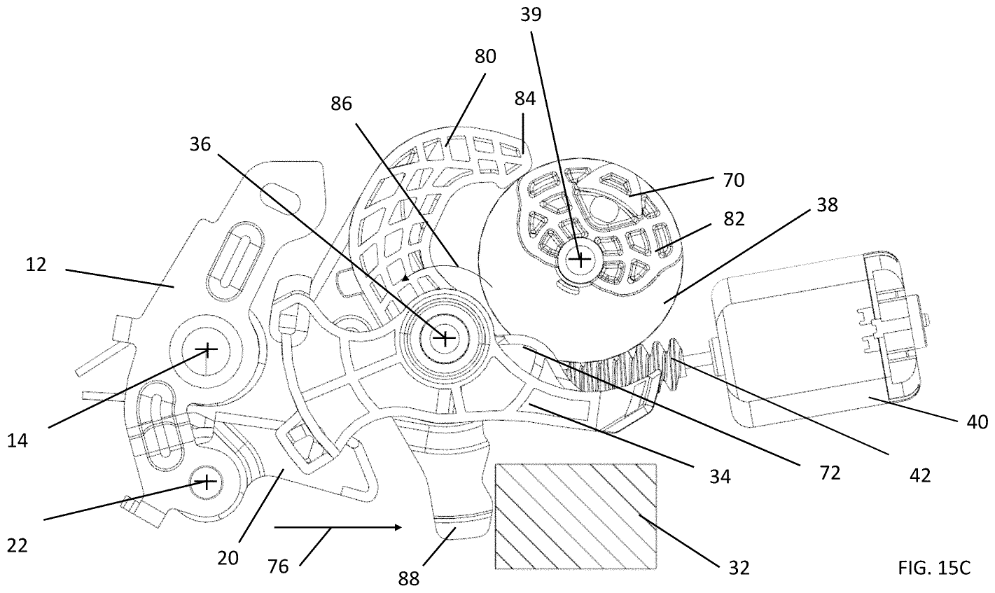

Referring now to FIGS. 14-15C, the latch system 10 is illustrated with a power release lever 80. As illustrated, the power release lever 80 is rotatably mounted to the latch assembly 10 and is also capable of movement about axis 36. In other words and in one non-limiting embodiment the power release lever 80 and the child lock lever 34 pivot about the same axis. The movement of the power release lever 80 is independent of the movement of the child lock lever 34 and the movement of the child lock lever 34 is independent of the power release lever 80. The movement of the power release lever 80 is caused by a second cam surface 82 that engages an upper portion 84 of the power release lever 80 as the gear 38 is rotated by the worm 42. The second cam surface 82 is integrally formed with the gear 38 such that the second cam surface 82 rotates with the gear 38 and the second cam surface 82 and the gear 38 are formed as a single component.

As the gear 38 rotates counter clockwise about axis 39 with respect to the views illustrated in at least FIGS. 14-15C, the second cam surface 82 will contact the upper portion 84 of the power release lever 80 and the power release lever 80 will be rotated about axis 36 in the direction of arrow 86. During this movement a lower portion 88 of the power release lever 80 will contact the pawl release lever 32 and move the pawl release lever 32 in the direction of arrow 76 which will cause the pawl release lever 32 to rotate and the pawl 28 will be disengaged from the claw 26 and the latch 10 will open.

In an alternate set up of the system, the release link 20 could drive the power release lever 80 rather than the pawl release lever 32, or the release link 20 could be attached to the pawl release lever 32 and disengage from the inside release lever 12 (opposite set up) due to the movement of the child lock lever 34. The key point here is that movement of the child lock lever 34 disengages the inside release system of levers from being able to open the latch.

In one non-limiting embodiment, a single spring 90 is used to return the power release lever 80 and the child lock lever 34 to their respective home positions. As used herein, home positions of the power release lever 80 and the child lock lever 34 refer to their position prior to being rotated by gear 38. In an alternative embodiment, two separate springs could be used one for the power release lever 80 and the other for the child lock lever 34.

In one non-limiting embodiment, a single spring is used to return the power release lever 80 and the child lock lever 34 rotate about the same axis 36. Alternatively, they could pivot or rotate on separate axes.

In one embodiment, the child lock switch 46 is activated off the child lock lever 34 for a 2-lever design (e.g., separate power release lever 80 and the child lock lever 34). For a single lever design the child lock switch 46 would be activated off the power release lever 80. In yet another alternative embodiment the child lock switch 46 can be activated off the gear 38 or the release link and provide the same function.

In accordance with various embodiments of the present disclosure, the child lock switch 46 turns on if the child lock lever 34 begins to displace the release link 20 in any way (indicates partial disengagement), and a fully “locked” condition is determined by the child lock switch turning on and the gear 38 being driven to stall against a hard stop such that the gear is no longer rotating will be that the child lock system is fully disengaged.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A latch assembly, comprising:
a manual release lever rotationally mounted to the latch assembly for movement about a first axis, the manual release lever being operably coupled to an inside release handle;
a release link pivotally mounted to the manual release lever for movement about a second axis;
a child lock lever rotationally mounted to the latch assembly for movement about a third axis;
a gear rotationally mounted to the latch assembly for movement about a fourth axis, the gear being rotated by a motor that drives a worm that meshingly engages teeth of the gear;
a child lock switch positioned to detect a position of the child lock lever;
a gear home switch positioned to detect the position of the gear; and
wherein the gear has a first cam surface configured to contact a cam surface of the child lock lever when the gear is rotated to a locked position and contact of the first cam surface with the cam surface of the child lock lever will rotate the child lock lever about the third axis and rotation of the child lock lever about the third axis will cause the release link to pivot about the second axis.

2. The latch assembly as in claim 1, wherein rotation of the gear to the locked position will decouple the manual release lever from a pawl of the latch assembly.

3. The latch assembly as in claim 1, wherein rotation of the gear to the locked position will cause the child lock lever to contact the child lock switch.

4. The latch assembly as in claim 1, wherein the first cam surface of the gear is integrally molded with the gear such that the first cam surface of the gear and the gear are formed as a single component.

5. The latch assembly as in claim 1, wherein the child lock switch and the gear home switch are coupled to a controller that controls the operation of the latch assembly by providing signals to the motor in order to rotate the gear.

6. The latch assembly as in claim 1, further comprising a power release lever rotatably mounted to the latch assembly for movement about the third axis, wherein rotation of the power release lever by the gear causes a pawl of the latch assembly to be disengaged from a claw of the latch assembly.

7. The latch assembly as in claim 6, wherein the power release lever rotates independently of the child lock lever.

8. The latch assembly as in claim 7, wherein the gear has a second cam surface that engages an upper portion of the power release lever as the gear is rotated by the worm.

9. The latch assembly as in claim 8, wherein the second cam surface is integrally formed with the gear such that the second cam surface rotates with the gear and the second cam surface and the gear are formed as a single component.

10. The latch assembly as in claim 9, wherein a lower portion of the power release lever contacts a pawl release lever operably coupled to the pawl when the power release lever is rotated by the gear.

11. The latch assembly as in claim 8, wherein a lower portion of the power release lever contacts a pawl release lever operably coupled to the pawl when the power release lever is rotated by the gear.

12. The latch assembly as in claim 11, wherein operation of the motor in a first direction will move the power release lever and operation of the motor in a second direction opposite to the first direction will move the child lock lever.

13. The latch assembly as in claim 8, wherein rotation of the gear to the locked position will decouple the manual release lever from a pawl of the latch assembly.

14. The latch assembly as in claim 13, wherein rotation of the gear to the locked position will cause the child lock lever to contact the child lock switch.

15. The latch assembly as in claim 14, wherein the first cam surface of the gear is integrally molded with the gear such that the first cam surface of the gear and the gear are formed as a single component.

16. The latch assembly as in claim 15, wherein the child lock switch and the gear home switch are coupled to a controller that controls the operation of the latch assembly by providing signals to the motor in order to rotate the gear.

17. The latch assembly as in claim 16, wherein operation of the motor in a first direction will move the power release lever and operation of the motor in a second direction opposite to the first direction will move the child lock lever.

18. A method of operating a latch assembly, comprising:
decoupling a manual release lever from a pawl of the latch assembly by rotating a gear in a first direction by a motor; and
moving the pawl by rotating the gear in a second direction by the motor, the second direction being opposite to the first direction.
